(19) United States
(12) Patent Application Publication
(10) Pub. No.: US 2014/0115180 A1
(43) Pub. Date: Apr. 24, 2014

(54) MULTI-PLATFORM CONTENT STREAMING

(71) Applicants: Gustavo Neiva de Medeiros, New York, NY (US); Eric Jenkins, Montville, NJ (US); Darren Blumenveld, New York, NY (US)

(72) Inventors: Gustavo Neiva de Medeiros, New York, NY (US); Eric Jenkins, Montville, NJ (US); Darren Blumenveld, New York, NY (US)

(21) Appl. No.: 13/655,530

(22) Filed: Oct. 19, 2012

(51) Int. Cl. H04L 29/06

(52) U.S. Cl. CPC H04L 65/602
USPC 709/231

(57) ABSTRACT

A computer implemented method for providing streaming of a data stream received by a client, the method comprising receiving from the client a request for streaming the data stream onto a computer platform, capturing a data based on the request, converting the captured data through an encoder into multiple streams and streaming to the client at least one of the multiple streams.

### CROSS-REFERENCE TO RELATED APPLICATIONS

This application claims benefit of priority of U.S. Provisional Patent Application Ser. No. 61/564,613, filed Nov. 29, 2011, entitled “STREAMING SYSTEM AND METHOD”, owned by the assignee of the present application and herein incorporated by reference in its entirety.

### FIELD OF TECHNOLOGY

This disclosure relates generally to multi-platform content streaming and, more particularly, to streaming live and recorded content onto multiple platforms.

### BACKGROUND

The demand for traffic over the internet has been increasing significantly over the past few years. This increase is being driven by increased user consumption of data. For example, videos-such as user-generated short clips, as well as commercially produced TV shows and movies—as well as increasing resolution, and hence the increase in bytes of data that comprise such videos.

Presently, a typical way to deliver videos comprises using video servers, hosted in a centralized set of datacenters. In this scenario, when a user requests a video the data comprising that video is streamed, or downloaded, or progressively downloaded, to that user.

### SUMMARY

Disclosed are a method, an apparatus and/or a system of a multi-platform content streaming. In one aspect, a computer implemented method for providing streaming of a data stream received by a client includes receiving from the client a request for streaming the data stream onto a computer platform. The request includes a platform identification and the data stream is one of live and recorded content. The method further includes capturing a data based on the request. Further method includes converting the captured data through an encoder into multiple streams. Also, the method further includes streaming to the client at least one of the multiple streams.

In another aspect, captured data may be converted into multiple streams of varying quality. Further, the encoder may be coupled with an encoding manager. Also, the encoding manager may one of configure and reconfigure the name of one of the multiple streams. In addition, the encoding manager may poll for requests to the encoder and may monitor a stream interface and report a status.

In another aspect, a device includes one or more processors, memory and one or more programs. The one or more programs are stored in the memory and configured to be executed by the one or more processors, the programs include instructions for receiving from the client a request for streaming the data stream onto a computer platform. The request includes platform identification, and the data stream is one of live and recorded content. The program includes instructions for capturing a data based on the request. The program includes instructions for converting the captured data through an encoder into multiple streams. The program includes instructions for streaming to the client one of the multiple streams.

In another aspect, captured data may be converted into multiple streams of varying quality. Further, the encoder may be coupled with an encoding manager. Also, the encoding manager may one of configure and reconfigure the name of one of the multiple streams. In addition, the encoding manager may poll for requests to the encoder and may monitor a stream interface and report a status.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a multi-platform content streaming system, according to one or more embodiments.

FIG. 2 is another schematic view of a multi-platform content streaming system, according to one or more embodiments.

FIG. 3 is a process flow diagram detailing the operation of a multi-platform content streaming system, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of multi-platform content streaming. Although the present embodiments have been described with reference to specific example embodiments, it will be evident that various modifications and changes may be made to these embodiments without departing from the broader spirit and scope of the various embodiments.

In one or more embodiments, multi-platform content streaming system may be a scalable architecture that provides streaming of live and recorded content for viewing on multiple platforms. These viewing platforms may include a web-site, portable devices, set-top-boxes, TV apps. Additionally, a website may be optimized for viewing on different web-portals such as dedicated devices such as Sony Playstation™. Beyond that an API may be created to allow developers to create viewing platforms or plug-ins to existing platforms.

In one or more embodiments, multi-platform content streaming system may encode all content using Windows based computers with SD encoding cards. An encoder may be used to convert the captured signal into three media streams of different quality. These media streams may be sent to streaming server(s) for dissemination to customers. The streaming servers may scalable because they are standard systems running identical software that controls how streams are started, stopped and monitored for quality. Additionally an encoding manager may control where the stream is sent and what it is named. The encoding manager may communicate to a central management web-based console where it can be manually configured. Automatic central re-configuration may also in place to change the stream names in order to prevent theft of service.

In one or more embodiments, encoder manager may be a distributed system controlling a many-to-many mapping of encoding sources to encoding sinks.

In an example embodiment, Each encoding server may run the same Windows service (USTVNOWEncoderManager.exe) and at each encoding server the channel templates are defined based on how many capture cards are in the system. Further, the central database may contain records of each channel and where that channel's “sink” is. (E.g. Ch.1 is station XYZ, the stream is named stream XYZ and the stream is sent to LiveServer1). Still further, the encoding manager may poll for requests to begin encoding through an interface at the web-site. The encoding manager may start encoding the stream and send it to that Live Server. The Live server may query the database via the interface on the web-site.

In another example embodiment, once encoding is started, the encoding manager may monitor the stream instances for that encoding and report back to the website through the interface the status of the channel including vital information as stream latency and stream bandwidth and up and/or down status. The status changes may be used to notify support teams via email or admin web-page of any service issues and also to report to end-users if there is a service interruption. A service running on any administrative server may update and encrypt stream names in the database daily. Anytime a stream name is changed or any other information that would require a reconfiguration at the encoding server, the encoding server may detect this though the polling mechanism and will reconfigure the stream as required.

In an example embodiment, acquired streams may be sent to different streaming servers based on settings entered at the central management console. The multi-platform content streaming system may be scalable to allow different servers to be used. scalability may be allowed to manage inbound load, to manage geographic issues with the IP network.

In an example embodiment, multi-platform content streaming systems may get scheduling information from a central database and record the content requested. A platform may be scalable to expand to multiple servers and record any subset of an entire content offering. Scalability may be allowed to distribute load, storage requirements, and maintain high-availability. A Digital Video Recording module may pull the content from servers and write the three different quality streams to disk. Recorded content may be maintained for a specific period of time. The specific period of time may be set to ease requirements of storage. Users may playback recorded content, and delete when finished. Additionally, users may schedule to record a “series” which will record different episodes of the same show until this timer is deleted.

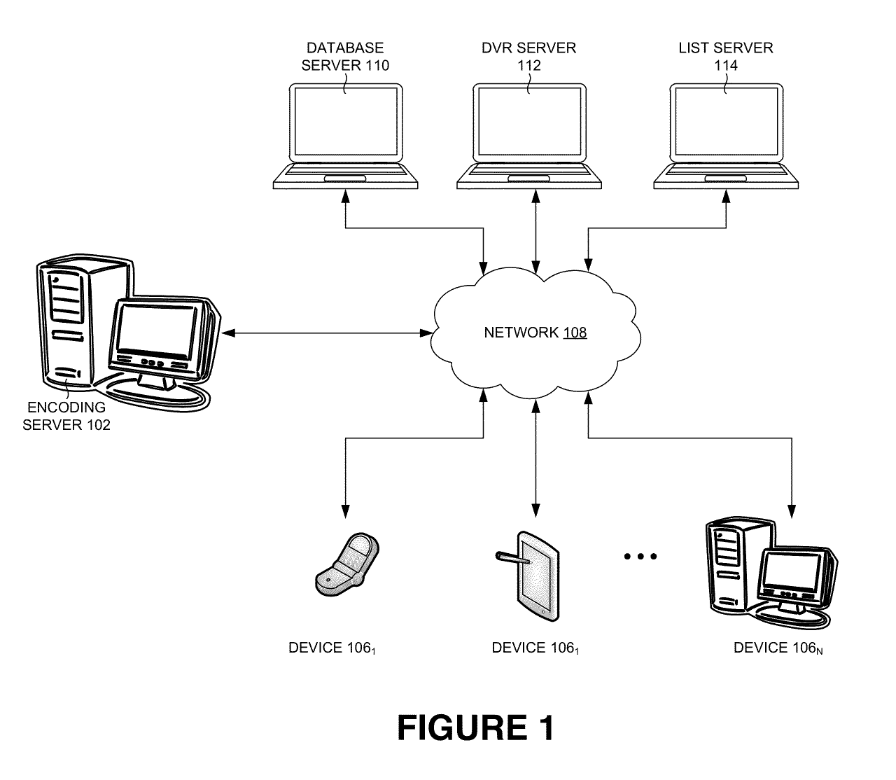

FIG. 1 shows a multi-platform content streaming system, according to one or more embodiments. The multi-platform content streaming system may include client devices 106_{1-N}. The client devices 106_{1-N} may be point of access to an interface for requesting a data stream. The client devices 106_{1-N} may be coupled to servers including database server 110, Digital video recording (DVR) server 112, list server 114 and an encoding server 102 through a network 108.

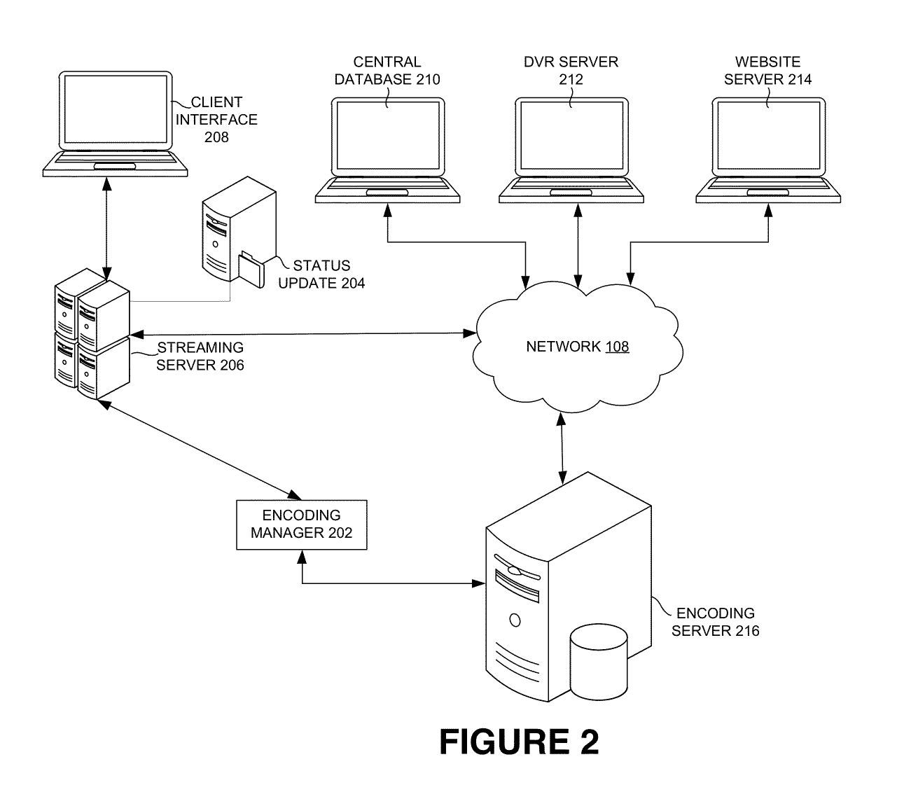

FIG. 2 shows a multi-platform content streaming system and a flow of data in the multi-platform content streaming system, according to one or more embodiments. A user of the multi-platform content streaming system may access a client interface 208 to request for a content stream. The request for the content stream may be relayed to a streaming server 206 which in turn is coupled to an encoding manager 202 and network 108. The streaming server 206 may receive updates from a status update 204 station. The updates may indicate a health of the data stream requested at various sources. The network 108 in seeking the data stream that may be requested is coupled to a DVR server 212, central database 210, website server 214 and an encoding server 216. One of DVR server 212, central database 210, website server 214 and an encoding server 216 may be coupled to the encoding manager 202.

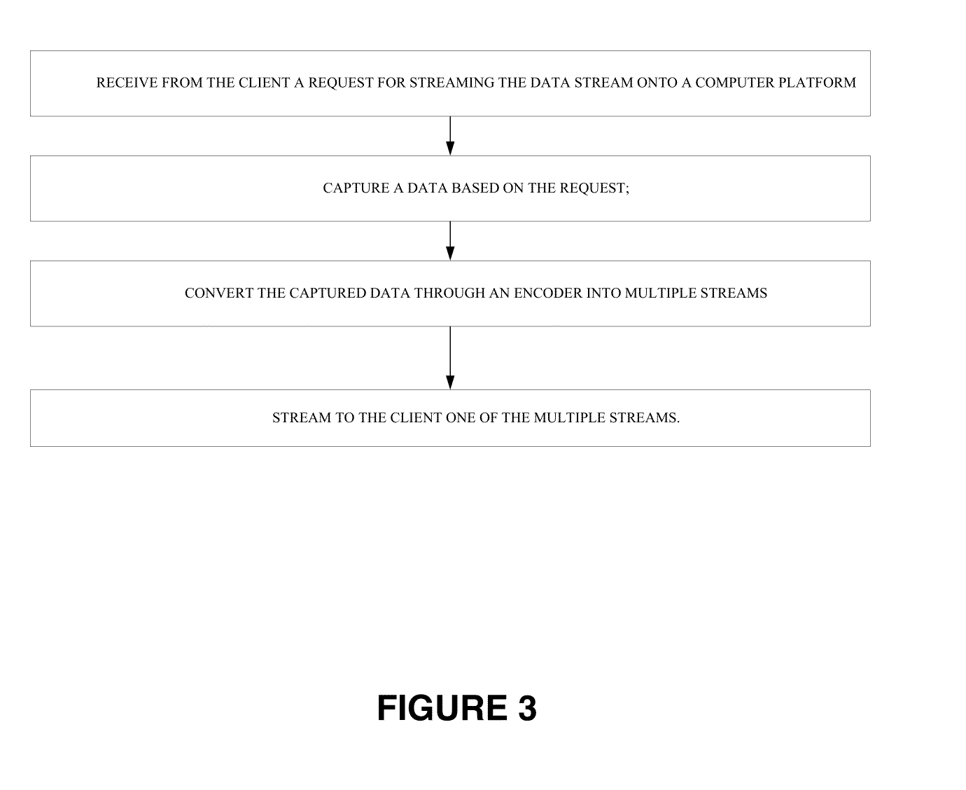

FIG. 3 shows a process flow diagram detailing the operations involved in a method of a multi-platform content streaming system, according to one or more embodiments. In one or more embodiments, operations of the multi-platform content streaming system may involve receiving from the client a request for streaming a data stream onto a computer platform, capturing a data based on the request, converting the captured data through an encoder into multiple streams and streaming to the client one of the multiple stream.

In an example embodiment, a computer implemented method for providing streaming of a data stream received by a client may include receiving from the client a request for streaming the data stream onto a computer platform. The request may include a platform identification, and the data stream may one of live and recorded content. The method may further include capturing a data based on the request. Further, the method may also include converting the captured data through an encoder into multiple streams and streaming to the client one of the multiple streams.

In an example embodiment, the captured data may be converted into multiple streams of varying quality.

In an example embodiment, the encoder may be coupled with an encoding manager. The encoding manager may one of configure and reconfigure the name of one of the multiple streams.

In an example embodiment, the encoding manager may poll for requests to the encoder.

In an example embodiment, a computer implemented method for providing streaming of a data stream received by a client may include receiving from the client a request for streaming the data stream onto a computer platform. The request for streaming data may have a price associated. The price paid by the client may buy the client recording time. The recording time may be length of time for which the data stream may be recorded. The data stream may be recorded onto a digital video recorder. The client may receive additional minutes of the recording time by referring friends. Referring friends may be recommending another client to subscribe to the data stream. Further, the client may choose to pay a price to keep recorded content for a specified duration of time. The client may choose to increase the price paid to be able to store the recorded for extended duration of time in addition to specified duration that was bought before. The request may include a platform identification, and the data stream may one of live and recorded content. The method may further include capturing a data based on the request. Further, the method may also include converting the captured data through an encoder into multiple streams and streaming to the client one of the multiple streams.

In an example embodiment, the encoding manager may monitor a stream interface and reports a status. In another example embodiment, a location, length of duration of availability of data stream and length of time for which data stream was interrupted on a per client basis may be stored. The stored data such as location, length of duration of availability of data stream and length of time for which data stream was interrupted on a per client basis may be accessed by the client. The client may be able to access the stored data so that he can decide amongst various streams that are available for subscription.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A computer implemented method for providing streaming of a data stream received by a client, the method comprising:
receiving from the client a request for streaming the data stream onto a computer platform,
wherein the request includes a platform identification, and
wherein the data stream is one of live and recorded content;
capturing a data based on the request;
converting the captured data through an encoder into multiple streams; and
streaming to the client at least one of the multiple streams.

2. The method of claim 1, further comprising: wherein the captured data is converted into multiple streams of varying quality.

3. The method of claim 1, further comprising: coupling the encoder with an encoding manager,
wherein the encoding manager one of configures and reconfigures the name of one of the multiple streams.

4. The method of claim 3, further comprising: wherein the encoding manager polls for requests to the encoder.

5. The method of claim 4, further comprising: wherein the encoding manager monitors a stream interface and reports a status.

6. A device, comprising:
one or more processors;
memory; and
one or more programs, wherein the one or more programs are stored in the memory and configured to be executed by the one or more processors, the programs including:
instructions for receiving from the client a request for streaming the data stream onto a computer platform,
wherein the request includes a platform identification, and
wherein the data stream is one of live and recorded content;
instructions for capturing a data based on the request;
instructions for converting the captured data through an encoder into multiple streams; and
instructions for streaming to the client at least one of the multiple streams.

7. The device of claim 6, further comprising: wherein the captured data is converted in to multiple streams of varying quality.

8. The device of claim 6, further comprising: coupling the encoder with an encoding manager,
wherein the encoding manager one of configures and reconfigures the name of one of the multiple streams,

9. The device of claim 7, further comprising: wherein the encoding manager polls for requests to the encoder.

10. The device of claim 8, further comprising: wherein the encoding manager monitors a stream interface and reports a status.
